(19) United States
(12) Patent Application Publication
(10) Pub. No.: US 2004/0154921 A1
(43) Pub. Date: Aug. 12, 2004

(54) Method for electrophoretic sample separation

(76) Inventor: Kai H. Te Kaat, Frankfurt (DE)

Correspondence Address: CONNOLLY BOVE LODGE & HUTZ, LLP, P O BOX 2207, WILMINGTON, DE, 19899, US

(21) Appl. No.: 10/479,454

(22) PCT Filed: May 31, 2002
(86) PCT No.: PCT/EP02/05969

(30) Foreign Application Priority Data
Jun. 6, 2001 (DE) 101 27 406.8

(51) Int. Cl. G01N 27/26

(52) U.S. Cl. 204/450; 204/548

(57) ABSTRACT

The present invention relates to a method for electrophoretically separating peptides and proteins, in particular by isoelectric focusing using a mixture composed of a polar liquid and at least one amphiphilic substance which forms a liquid-crystalline phase, as separation matrix.

The present invention relates to a method for electrophoretically separating samples, in particular by means of isoelectric focusing, using a suitable separation matrix. The invention is particularly suitable for fractionating lipophilic peptide and protein constituents in a sample.

In the biosciences, electrophoresis has for a long time now been known standard technology for fractionating charged molecules. In electrophoresis, charged molecules migrate in an electric field in dependence on their surface charge, their molecular weight and their spatial measurements and in dependence on the viscosity of the separating medium. The separation takes place because individual charge molecules migrate at different rates, with these rates being brought about by the aforementioned dependencies. The electrophoresis of biomolecules is typically carried out in aqueous solutions. In order to prevent the sample mixing as a result of convection, the electrophoresis is as a rule carried out in highly porous matrices, such as polyacrylamide or agarose gels. In this case, the sample constituents are to a first approximation separated on the basis of the average pore size of the gel and the molecular weight of the sample constituent. This principle is used, for example, in SDS-PAGE electrophoresis for separating proteins in a sample. Righetti, P. G. et al., J. Chromatogr. B 699 (1996) 63-75; Righetti, P. G. et al., J. Chromatogr. A 698 (1995) 3-17; Righetti, P. G. et al., Electrophoresis 1995, 16, 1815-1829; and Manabe, T., Electrophoresis 21, 1116-1122, for example, provide an overview of the methods which already exist and the separating media which are used for these methods.

An alternative method is that of fractionating with the aid of a pH gradient (see, e.g., Molloy, M. P. Analytical Biochemistry 280, 1-10 (2000); Righetti, P. G. et al., J. Chromatogr. B 699 (1997) 77-89), which can be set up between the two electrodes in order to separate molecules from each other on the basis of their isoelectric points. In a pH gradient, amphoteric analytes carry a net surface charge until the analyte has migrated to a region of the gel in which the pH corresponds to the isoelectric point of the analyte. As a result, the migration of the analyte in the electric field comes to a standstill at the isoelectric point, i.e. the analyte is focused in this region. Anticonvective media which have a high average pore size and which impede the migration of the analyte as little as possible are typically used for isoelectric focusing. Preference is also given to using agarose gels or polyacrylamide gels, under low salt conditions, for isoelectrically separating biomolecules.

The protein constituents in a sample which is to be separated electrophoretically can be divided into readily separable water-soluble proteins and into fat-soluble proteins. Thus, the cell membrane-spanning proteins, in particular, possess extensive hydrophobic regions within the transmembrane domains and hydrophilic intracellular and extracellular head domains. These membrane proteins are only very sparingly soluble in aqueous phases and cannot, therefore, be separated electrophoretically using conventional means. Detergents are used as a rule for solubilizing membrane proteins in a suitable manner for electrophoresis (Rabilloud, T., Electrophoresis 1996, 17, 813-829; Herbert, B. Electrophoresis 1999, 20, 600-663, Molloy, M. P. Analytical Biochemistry 280, 1-10 (2000)). In the case of isoelectric focusing, in particular, it is necessary to use either uncharged or zwitterionic detergents, which only have a limited capacity to dissolve lipophilic proteins. Consequently, very efficient methods are available for electrophoretically separating water-soluble proteins, whereas the separation of protein mixtures which contain lipophilic proteins still suffers from problems.

An object of the present invention was therefore to provide a method which enables chemical and biological samples, particularly including their hydrophobic constituents, to be separated.

It was surprisingly possible to achieve this object by using a separating medium which comprises a mixture of a polar liquid and a liquid-crystalline phase composed of at least one amphiphilic substance, with the liquid-crystalline phase serving as the separation matrix.

In polar liquids, these amphiphilic substances form a three-dimensional, double membrane-like liquid-crystalline network which is interlaced with channels of the liquid phase.

After the dissolved sample has been loaded onto this separating medium, the electrophoretic separation is effected by applying an electric field. In the case of an isoelectric focusing, the sample can also be present in a state in which it is mixed with the separating medium or with the amphiphilic substances.

As a consequence of using the amphiphilic liquid-crystalline separation matrix, lipophilic substances, such as lipophilic peptides, proteins or glycoproteins, are surprisingly able to migrate directly, when an electric field is applied, without diffusing into the polar liquid. In addition, the liquid-crystalline phases composed of amphiphilic substances are able, without using detergents, to solubilize hydrophobic peptides and proteins and consequently bring them into a state in which they can be fractionated electrophoretically. In addition to this, such phases form, in polar liquids, a porous separation matrix which additionally ensures the separation of substances which are soluble in polar solvents, which means that a mixture composed of hydrophobic and hydrophilic peptides and proteins can also be efficiently separated. Separation by means of the methods according to the invention is consequently suitable particularly for mixtures which also contain glycolipids, ionic lipids, carbohydrates, sugars, amino acids, nucleic acids or secondary metabolites in addition to peptides and proteins. In addition, the separation matrix prevents convection currents and the undesirable intermixing, which is associated therewith, of the separating medium. Surprisingly, the separation matrix was found to be stable under the electrophoresis conditions.

Any uncharged amphiphilic substances which have a hydrophobic molecular unit (tail) and a hydrophilic molecular unit (head), and which are able to form a liquid-crystalline phase in polar liquids, can be used for producing the separation matrix. These substances include, in particular, alcohol fatty acid esters, in particular composed of short-chain C₂-C₄ alcohols having up to 4 hydroxyl groups and C₈-C₃₀ fatty acids, with it being possible for some of the hydroxyl groups to be present in free form or to be present together with other chemical groups, such as phosphoric acid derivatives, amino alcohols or saccharides, with the formation of phosphatides, glycolipids or amino lipids.

The amphiphilic esters employed preferably contain, as acyl groups, C₁₂-C₂₄ fatty acids which are unsaturated once to five times or saturated C₈-C₂₀ fatty acids; the esters particularly preferably contain singly unsaturated cis-C₁₄-C₂₂-acyl groups, such as 1-monooleoyl-rac-glycerol, 1-monomyristoyl-rac-glycerol or 1-monopalmitoyl-rac-glycerol.

Monoacylglycerides, diacylglycerides, acylglycerol phosphatides, glycoacylglycerides and aminoacylglycerides, or a mixture containing such substances, are particularly suitable amphiphilic substances.

The preparation of liquid-crystalline phases, proceeding from the above-described amphiphilic substances, and their properties are described, for example, in WO 84/02076 and WO 98/10281. In addition, a detailed description of liquid-crystalline cubic phases can also be found in Landau, E. M. et al., Proc. Natl. Acad. Sci. Vol. 93, pp. 14532-14535 Dec. (1996); Nollert, P. et al., FEBS Letters 457 (1999) 205-208; Caffrey M., Current Op. Structural Biol. 10, 486-497 (2000); Hong, Q. et al., Biomaterials 21, 223-234 (2000), who only use these phases for protein crystallization, however.

Different liquid-crystalline phases can be used for the purpose of electrophoretically separating chemical and biological samples. However, preference is given to cubic phases which form a single, continuous network which is interlaced with channels which are connected to each other and which contain the polar liquid. In such phases, the hydrophobic peptides and proteins, for example, can migrate in the double membrane-like separation matrix without having to pass through the liquid channels. However, liquid-crystalline phases having a lamellar, hexagonal or inverted hexagonal structure are also preferentially suitable for the electrophoretic separation. In this connection, it is advantageous if the membrane-like lamellae are aligned in the longitudinal direction to the electric field in order to ensure a migration within the separation matrix which is as interference-free as possible.

In addition to this, cubic phases are particularly suitable for electrophoretically separating peptides and proteins for the following reasons:

The thickness of the membrane-like cubic phase is virtually homogeneous; other phases, such as lamellar or hexagonal or inverted hexagonal phases, have hydrophobic membrane regions which are of differing thickness.

The liquid-crystalline cubic phase is an isotropic phase. The physical and chemical properties of this phase are identical in all three dimensions, which means that it is not necessary for the phase to be orientated in relation to the electric field which is applied. In the case of anisotropic phases, it is advantageous to align the membrane planes parallel to the electric field in order to permit mobility of the proteins in the membrane plane.

The liquid-crystalline cubic phase is stable in the presence of an excess of water. In the electrophoresis, it is possible to use different buffers in order to enable current conduction to take place between the electrodes and the ends of the matrix. It is therefore not desirable for the matrix to decompose slowly in an excess of buffer.

According to the monoolein-water phase diagram, cubic phases are formed over a wide range of from approx. 10 to max. 50% water content at temperatures of from 5 to approx. 95 degrees centigrade and at atmospheric pressure. An aqueous phase:MO composition of from 25:75 to 40:60 (v/v), at a temperature of from 20 to 40 degrees centigrade, is preferred.

Various auxiliary substances can be admixed, at a concentration of from 0.1% to 15% (w/w), preferably of between 1% to 5% (w/w)₁ with the liquid-crystalline phases. The auxiliary substances to be considered here are, in particular, lipids and detergents, since admixing these substances may possibly be of importance in solubilizing difficult membrane proteins. There are also a number of membrane proteins which have specifically bound a particular lipid, for example as a biological cofactor.

Synthetic or naturally occurring lipids, such as phosphatidylcholine, phosphatidylethanolamine, charged or uncharged phospholipids, sphingolipids or glycolipids, fat-soluble biological cofactors, chlorophylls, retinol, steroids, carotenoids, quinones or C₈-C₃₀-fatty acids, -alkanes, -alkenes, -alkynes or -alcohols can, for example, be added to the amphiphilic phase. Lipids or detergents possessing ionic or zwitterionic head groups are auxiliary substances which are preferably added.

Other small polar amphiphilic substances, polar glycols, sugar monomers or multimers, amino acids or zwitterionic substances can be added, as auxiliary substances, to the polar liquid. Glycerol, ethylene glycol, propylene glycol, polyethylene glycol, glycine, urea or guanidine are examples of possible auxiliary substances, depending on the electrophoretic method.

In addition to this, it is possible to add carrier ampholytes, which can be used to construct a pH gradient in the separating medium, to the polar liquid. Ampholine®, in a concentration range of from 0.1 to 40% by vol., preferably of from 2 to 8% by vol., is an example of a suitable carrier ampholyte. Electrophoresis in a pH gradient enables isoelectric focusing to be used to separate proteins on the basis of their isoelectric points.

As a rule, the separating medium is buffered; preference is given to using Tris buffers. An acid, preferably dilute phosphoric acid, is used as the anolyte in the isoelectric focusing. The electrophoretic separations are preferably carried out in a capillary at a voltage of less than 8000 V, preferably at a voltage of between 100 V and 600 V. As a rule, the running times are between 0.5 h to 10 h. However, preference is given to voltages and running times which give a Vh value of less than 4000 in order to prevent any possible change in the separating medium.

Another advantage of the method according to the invention lies in the fact that it is easy to prepare the samples. Thus, it is possible to dispense with adding detergents for the purpose of solubilizing lipophilic peptides and proteins. By contrast, it is possible, for example, to mix a centrifuged vesicle fraction or membrane fraction directly with the amphiphilic substances forming the liquid-crystalline phase. The peptides and proteins which are present in the membranes dissolve without difficulty in the amphiphilic substance and the solution can be loaded directly, for the separation, onto a ready-to-use separating medium, containing an amphiphilic, liquid-crystalline phase, or alternatively can be used for preparing the separating medium by mixing with a polar liquid. The latter approach is suitable, for example, for preparing the separating medium for the isoelectric focusing.

The method according to the invention can be used for separating ionic analytes or analytes which can be ionized in an electric field. However, nonionic substances can also be modified with ionic groups and thereby made accessible to an electrophoretic method. The described methods are particularly suitable for separating samples containing ionic lipids, hydrophobic secondary metabolites, glycolipids, glycoproteins, peptides and proteins. However, it is also possible to simultaneously separate sugars, carbohydrates, nucleic acids, amino acids, etc., in the polar liquid phase of the same separating medium. For this reason, the described method is also suitable for analyzing total extracts as are analyzed in proteome analysis. A combination with a second separating method, in a 2D process, appears advantageous in this connection, with a separation using the method according to the invention preferably being performed as the first separation step.

Analytes and auxiliary substances are preferably added to the polar liquid or the amphiphilic substance at concentrations which do not conflict with the formation of a cubically liquid-crystalline amphiphilic phase.

Another advantage of using liquid-crystalline amphiphilic phases for electrophoretic separation in accordance with the described method lies in the ability to use the composition of the phase to regulate the fluidity of the latter. Thus, the fluidity of the liquid-crystalline phase can be lowered, for example, by increasing the use of glycides or phosphatides possessing saturated acyl groups. Unsaturated acyl groups, particularly in the cis configuration, increase the fluidity. Consequently, it is possible to regulate the migration rate of the sample constituents to be separated by way of the composition of the cubically crystalline phase as well as by way of the temperature or the voltage which is applied.

### SHORT DESCRIPTION OF THE FIGURES

FIG. 1 shows the electrophoresis of polar molecules in a separating medium composed of a cubically liquid-crystalline phase, composed of separation matrix, and an aqueous phase.

FIG. 2 shows the separation of two dyes, i.e. bromophenol blue and orange G, using a Tris-glycine-SDS buffer system.

FIG. 3 show the establishment of a pH gradient in the separating medium using bromophenol blue as indicator;

FIG. 3a shows a uniform pH in the separating medium at slightly basic pH, while FIG. 3b shows a pH gradient, from a slightly basic pH through to a pH of markedly less than 3.0, which is constructed using carrier ampholytes.

FIG. 4 shows the use of isoelectric focusing, while varying the separating conditions, to fractionate a heterogeneous mixture of a fluorescence-labeled protein.

FIG. 5 shows the electrophoretic migration of a fluorescence-labeled phosphatidylethanolamine while the electrophoresis conditions are varied.

FIG. 6 shows the electrophoretic separation of a fluorescein isothiocyanate (FITC)-labeled peptide on an LCP separation matrix at different running times.

FIG. 7 shows a graph of the electrophoretic mobility of an FITC-labeled peptide using the experimental results depicted in FIG. 6.

Some implementation examples are given below for the purpose of clarifying the method according to the invention.

General Points:

The liquid-crystalline cubic phase (LCP) is prepared by mixing an aqueous phase with melted monoolein (MO, 1-monooleoyl-rac-glycerol) in a volume ratio of 30:70.

100-150 μg of solid MO are weighed out into an Eppendorf tube and overlaid with N₂. The weighed-out MO is melted at approx. 60 degrees C., and for 5 min, in an oven. The melted MO is then degassed for approx. 5 min in an ultrasonic bath. 70 μl of liquid MO are then sucked up, while excluding air bubbles, into a prewarmed Hamilton syringe.

An aqueous phase having the following composition is used for the isoelectric focusing:

10 μl of the carrier ampholyte Ampholine® (Amersham-Pharmacia) (final concentration up to approx. 8% in the aqueous phase) and H₂O qsp 50 μl. The aqueous phase is mixed and degassed by ultrasound, after which 30 μl of the aqueous phase are aliquoted into a second Hamilton syringe.

The syringes of the two syringes are coupled together head-to-head and the two phases are mixed by forcing them through from one syringe into the other approx. 100-200 times.

The LCP forms spontaneously when the aqueous phase is intermixed homogeneously with the melted MO and can be recognized by the fact that the phase appears completely clear and transparent.

Purified protein, a protein mixture, a vesicle preparation or dyes are used, for example, as the sample.

In the following implementation examples, the separation takes place at a temperature of 30 degrees centigrade.

Unless explicitly specified otherwise in the implementation examples, the general electrophoresis conditions are as follows:

cathode buffer: 0.1 M TRIS-SO₄ pH 9.3

anode buffer: 0.08 M H₃PO₄

field strengths (SI is V/m, in this present case V/column length) and electrophoresis duration:

1 h at approx. 100 V/60 mm

1 h at approx. 240 V/60 mm

4-24 h at 600 V/60 mm

### EXAMPLE 1

Electrophoresis of Polar Molecules in a Liquid-Crystalline Cubic Phase (LCP):

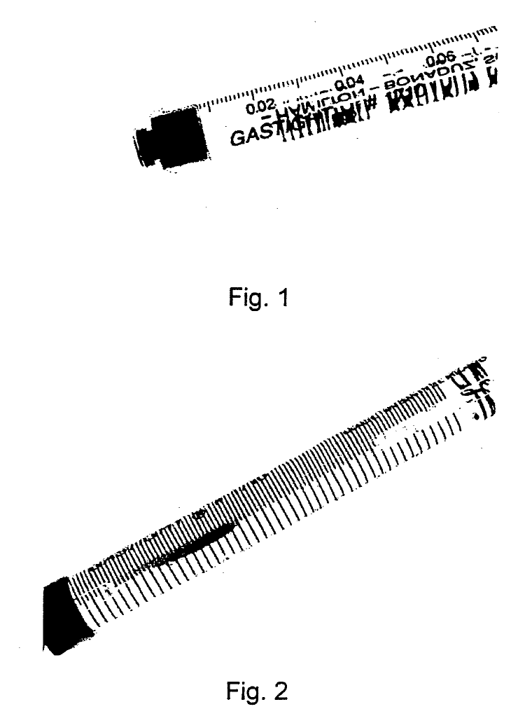

35 μl of an LCP are mixed with 100 mM Tris-HCl, pH 7.4; Tris:monoolein 30:70 (v/v) such that an LCP is formed. A 100 mM Tris HCl, pH 7.4, buffer is used as the electrophoresis buffer at the anode and the cathode. An anionic dye orange G (1 mg/ml) is used as the analyte. 5 μl of the analyte were deposited at the cathode on the surface of the LCP on the thread side of the syringe and subjected to a voltage of 300 V for approx. 15 min. Orange G has migrated into the clear LCP. A sharp migration front is visible (in this regard, see FIG. 1). Electrophoresis of charged molecules in LCP is consequently possible.

### EXAMPLE 2

Using a Tris-glycine-SDS Buffer System to Separate Two Dyes.

In 100 μl of an LCP consisting of electrophoresis buffer: monoolein in a ratio of 30:70 (v/v), with the electrophoresis buffer consisting of 25 mM Tris, 192 mM glycine and 0.1% (w/v) sodium dodecyl sulfate (SDS), 5 μl of an analyte composed of a mixture of bromophenol blue and orange G, both anionic dyes, are deposited, in a concentration of approx. 1 mg/ml, on the surface of the LCP at the cathode. The electrophoresis is carried out at 100 V for 1 h, at 240 V for 1 h and at 600 V for 6 h.

The electrophoretic mobilities of the two dyes differ, resulting in their being separated in the LCP (FIG. 2). Longer electrophoresis can lead to the matrix being altered (milky-white regions in the matrix at the right-hand end close to the anode).

### EXAMPLE 3

Establishing a pH Gradient.

The LCP consisting of an aqueous phase and monoolein in a ratio of 30:70 (v/v) is used for this purpose. The aqueous phase is composed of 5% Ampholine® 3.5-9.5 (Amersham-Pharmacia) in water containing bromophenol blue as the pH indicator. An 0.08 M H3PO4 solution is used as the anolyte while an 0.1 M Tris-SO4, pH 9.3, solution is used as the catholyte. The electrophoresis is carried out at 100 V for 1 h, 240 V for 1 h and 600 V for 4*₁ h.

It was possible to establish a pH gradient, which was recognizable from the differing colors of the pH indicator.

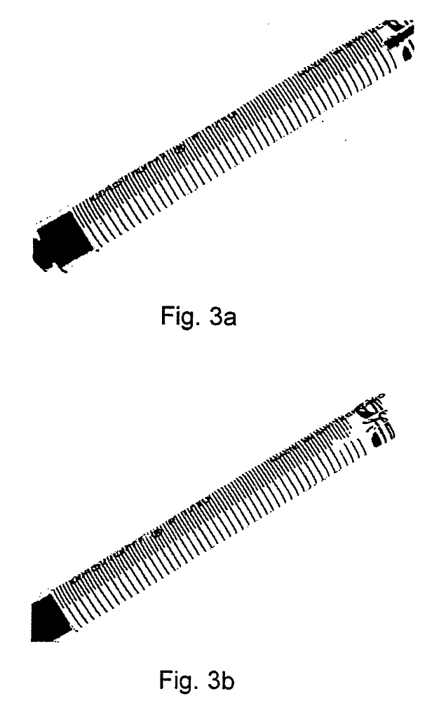

The pH gradient is established by means of carrier ampholytes. The LCP is stained with bromophenol blue. In the alkaline region, bromophenol blue is colored blue, with the color changing, over the pH range 4.6-3.0, through green to yellow, at a pH of 3.0 and below. FIG. 3a shows the homogeneously mixed LCP prior to the electrophoresis. FIG. 3b shows the established pH gradient after the electrophoresis.

### EXAMPLE 4

Fractionating a Heterogeneous Mixture of Fluorescence-Labeled Protein.

It was possible to detect heterogeneously labeled lysozyme, which was labeled with a Cy3 fluorescent dye, in the LCP using fluorescence scanning and to focus it in different bands. The electrophoresis conditions chosen were those used in example 3.

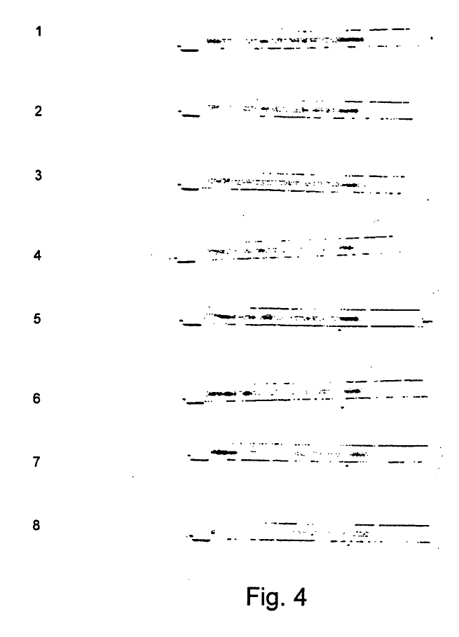

FIG. 4 shows the results of electrophoretically separating Cy3-labeled lysozyme in an LCP. FIG. 4 shows, from the top and downward:

1. LCP homogeneously mixed with Cy3-lysozyme,

2. after 1.5 h of isoelectric focusing at 100 V (150 Vh)

3. after 1 h of isoelectric focusing at 600 V (750 Vh)

4. after 2.5 h of isoelectric focusing at 600 V (1650 Vh)

5. after 3.5 h of isoelectric focusing at 600 V (2250 Vh)

6. after 4.7 h of isoelectric focusing at 600 V (2970 Vh)

7. after 6.5 h of isoelectric focusing at 600 V (4050 Vh)

8. after 8 h of isoelectric focusing at 600 V (4950 Vh)

It can be seen that the different proteins are focused in bands and then drift to the cathode.

### EXAMPLE 5

Directly Solubilizing Membrane Proteins, Solubilizing Membrane Proteins in an LCP.

Chromatophores are used as a model system for this purpose. The chromatophores are cytoplasmic membrane vesicles from a prokaryote containing photosynthetic membrane proteins which have bound color pigments such as chlorophylls, cytochromes, etc. After the vesicles have been mixed with MO in a ratio of 30:70 (v/v) to give a homogeneously greenish LCP, which does not exhibit any visible pellet even after 10 h of centrifugation at 55000 g, in all 150 μg of total protein are dissolved in 100 μg of LCP. It is consequently possible to directly solubilize a membrane protein mixture in a detergent-free manner.

### EXAMPLE 6

Electrophoretically Separating a Fluorescence-Labeled Phosphatidylethanolamine on an LCP Separation Matrix.

A monofunctional fluorescent dye Cy5 dye (Amersham, No.: PA25001) was coupled, in accordance with the manufacturer's instructions, to phosphatidylethanolamine (PE) to give a Cy5-PE conjugate (solvent: 50 mM HEPES, pH 9.0, in 90% MeOH), which was purified by TLC (Silica 60 HPTLC plates, Merck 1.05631; mobile phase 60:35:8 v:v:v CHCl3:MeOH:H2O).

The reaction product gave the expected mass distribution in MALDI-TOF-MS.

For the isoelectric focusing, use is made of an LCP having a composition comprising 70 μl of liquid, degassed monoolein (MO) and 30 μl of aqueous phase comprising Ampholine® 9.5-3.5 (Amersham-Pharmacia) diluted 1:5 in H₂O containing Cy5-PE as the analyte. The anolyte which is used is an 0.08 M H₃PO₄ solution while the catholyte which is used is an 0.1 M TRIS-SO₄, pH 9.3, solution.

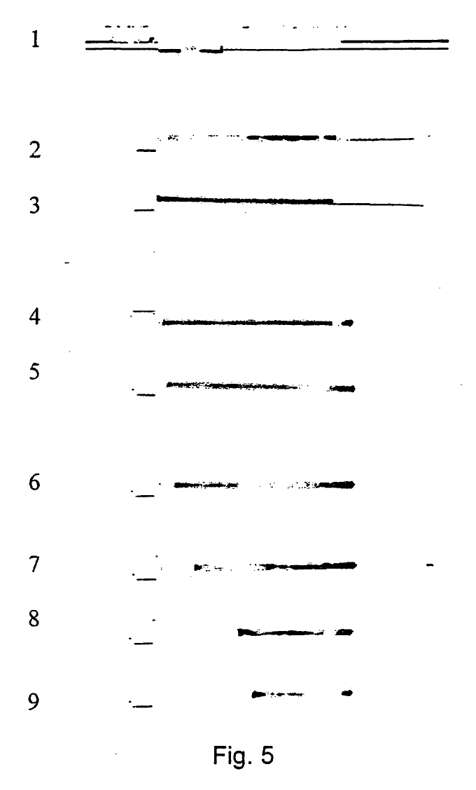

The results of the isoelectric focusing, obtained while varying the focusing conditions, are depicted in FIG. 5. FIG. 5 shows the results, from the top and downward, of the following experiments:

1. the fluorescent Cy5-PE conjugate is visible on the left as a black precipitate in the aqueous phase containing Ampholine® 9.5-3.5; the syringe on the right contains melted MO.

2. shows that the distribution of the analyte in the separating medium is still not homogeneous, and consequently the distribution of the LCP in the aqueous phase is still not homogeneous, after approx. 100 mixing steps,

3. shows that the distribution of the analyte in the separating medium is homogeneous after approx. 200 mixings

4. shows the result of the electrophoresis at 100 V after 1 h (100 Vh)

5. shows the result of the electrophoresis at 100 V after 3 h (300 Vh)

6. shows the result of the electrophoresis at 600 V after 1.5 h (900 Vh)

7. shows the result of the electrophoresis at 600 V after 2.5 h (1500 Vh)

8. shows the result of the electrophoresis at 600 V after 3.75 h (2250 Vh)

9. shows the result of the electrophoresis at 600 V after 4.85 h (2910 Vh).

Cy5-PE cannot be detected in the anolyte (100 μl end of the syringe).

### EXAMPLE 7

Electrophoresis of a Fluorescein Isothiocyanate (FITC)-Labeled Peptide on an LCP Separation Matrix.

A fluorescein isothiocyanate (FITC)-labeled peptide having the sequence YVAD is used as the analyte.

A mixture composed of an LCP consisting of 70 μl of liquid, degassed monoolein (MO) and 30 μl of an aqueous phase consisting of 50 mM HEPES, pH 8.0, containing the analyte at a concentration of 0.125 mg of FITC-YVAD/ml, is [lacuna] as the separating medium.

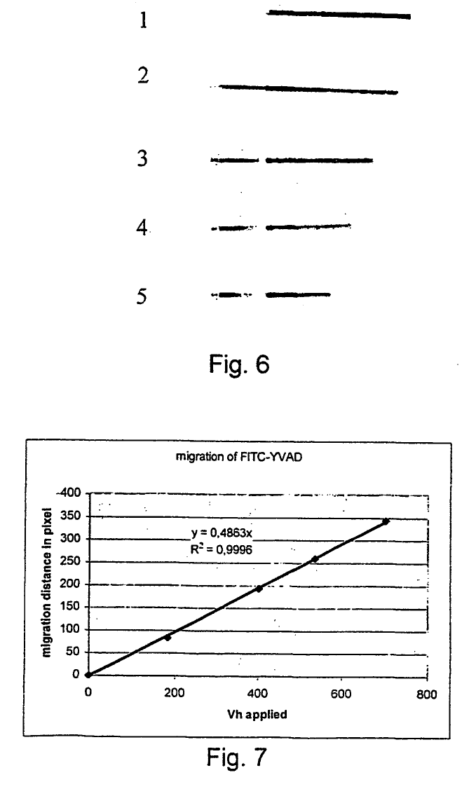

The electrophoresis is carried out at a constant 150 V using 50 mM HEPES as the anolyte and the catholyte. Because of the strongly hydrophobic amino acids YVA, the peptide which is used is only slightly soluble in water and carries negative charges on the fluorescein and in the aspartate side chain. During the electrophoresis, the labeled protein can be observed to migrate to the anode (FIG. 6, left-hand 100 μl end of the syringe). In conformity with its limited solubility in water, the peptide can also be found in the anolyte, thereby demonstrating that the aqueous domain of the LCP is in continuous communication with the surrounding buffer (in this regard, see example 6 as well).

FIG. 6 shows the results of the electrophoretic migration (anode on the left and cathode on the right) of the peptide analyte at an electrophoresis voltage of a constant 150 V:

1. after 0 Vh

2. after 182.5 Vh

3. after 402.5 Vh

4. after 535 Vh

5. after 702 Vh

Since a uniform buffer system was used, it is possible to deduce the electrophoretic mobility of the analyte: the distance migrated by the front is measured, for the evaluation, in pixels; at a fluorescence scanner resolution of 100 μm/pixel, one pixel corresponds to a migration distance of 100 μm:

Table 1 shows the electrophoretic mobility of FITC-YVAD determined as described in example 7.

TABLE 1

| Vh | pixel |
|---|---|
| 0 | 0 |
| 182.5 | 84 |
| 402.5 | 194 |
| 535 | 260 |
| 702.5 | 344 |

FIG. 7 shows a graph of the electrophoretic mobility.

1. A method for electrophoretically separating a sample containing lipophilic constituents, characterized in that a mixture composed of a polar liquid and of a separation matrix composed of at least one amphiphilic substance which forms a lamellar, hexagonal, inverted hexagonal or cubically liquid-crystalline phase is employed as the separating medium.

2. The method as claimed in claim 1, characterized in that the separating medium employed has a ratio of polar liquid to liquid-crystalline phase of between 10:90 and 50:50 (v/v).

3. The method as claimed in one of the preceding claims, characterized in that water is employed as the polar liquid.

4. The method as claimed in one of the preceding claims, characterized in that the amphiphilic substances employed are uncharged.

5. The method as claimed in one of the preceding claims, characterized in that the amphiphilic substances employed are alcohol fatty acid esters.

6. The method as claimed in claim 5, characterized in that the amphiphilic substances employed contains a C₂-C₄ alcohol having from 1 to 3 partially or completely esterified hydroxyl groups.

7. The method as claimed in one of the preceding claims, characterized in that the amphiphilic substance employed is selected from the group of the mono- or diacylglycerides, the acylglycerol phosphatides, the glycoacylglycerides and the aminoacylglycerides, or from a mixture containing such substances.

8. The method as claimed in claim 7, characterized in that the amphiphilic substances employed contain C₈-C₃₀ acyl groups.

9. The method as claimed in claim 7, characterized in that the amphiphilic substances employed contain, as acyl groups, esterified C₁₂-C₂₄ fatty acids which are unsaturated once to five times or saturated, esterified C₈-C₂₀ fatty acids.

10. The method as claimed in claim 7, characterized in that the amphiphilic substances employed contain, as acyl groups, esterified, singly unsaturated cis-C₁₄-C₂₂ fatty acids.

11. The method as claimed in claim 7 characterized in that the amphiphilic substance employed is 1-monooleoyl-rac-glycerol, 1-monomyristoyl-rac-glycerol or 1-monopalmitoyl-rac-glycerol.

12. The method as claimed in one of the preceding claims, characterized in that other auxiliary substances from the group of the detergents, of the synthetic or naturally occurring lipids, of the fat-soluble biological cofactors, fatty acids or of the C₈-C₃₀-alkanes, -alkenes, -alkynes or -alcohols are added to the liquid-crystalline phase.

13. The method as claimed in claim 12, characterized in that phosphatidylcholine, phosphatidylethanolamine, charged or uncharged phospholipids, sphingolipids or glycolipids, chlorophylls, retinol, steroids, carotenoids or quinones are added, as auxiliary substances, to the amphiphilic phase.

14. The method as claimed in claim 12, characterized in that lipids or detergents having ionic or zwitterionic head groups are added.

15. The method as claimed in one of the preceding claims, characterized in that carrier ampholytes are added to the polar liquid.

16. The method as claimed in claim 15, characterized in that Ampholine®, in a concentration range of from 0.1 to 40% by vol., is employed as the carrier ampholyte.

17. The method as claimed in claim 15, characterized in that Ampholine®, in a concentration range of from 2 to 8% by vol., is employed as the carrier ampholyte.

18. The method as claimed in one of the preceding claims, characterized in that small polar amphiphilic substances, polar glycols, sugar monomers or multimers, amino acids or zwitterionic substances are added, as auxiliary substances, to the polar liquid.

19. The method as claimed in claim 18, characterized in that the auxiliary substances which are added are selected from the group glycerol, ethylene glycol, propylene glycol, polyethylene glycol, glycine, urea and guanidine.

20. The method as claimed in one of the preceding claims, characterized in that the polar liquid employed is buffered.

21. The method as claimed in one of the preceding claims, characterized in that a pH gradient is established in the separating medium.

22. The method as claimed in claim 21, characterized in that the electrophoretic separating method is isoelectric focusing.

23. The method as claimed in claim 22, characterized in that the analytes are dissolved in the separating medium before beginning the separation.

24. The method as claimed in claim 22, characterized in that the hydrophobic analytes are dissolved in the liquid-crystalline phase before beginning the separation.

25. The method as claimed in one of the preceding claims, characterized in that the electrophoretic separation is carried out at a temperature of from 20 to 40° C.

26. The method as claimed in one of the preceding claims, characterized in that the electrophoretic separation is carried out at a voltage of between 100 V and 8000 V.

27. The method as claimed in one of the preceding claims, characterized in that ionic or ionized lipids, metabolites, carbohydrates, sugars, glycolipids, nucleic acids, amino acids, glycoproteins, peptides and proteins are separated electrophoretically.

28. The method as claimed in one of the preceding claims, characterized in that ionic or ionized lipids, metabolites, carbohydrates, sugars, glycolipids, nucleic acids, amino acids, glycoproteins, peptides and proteins are separated electrophoretically by means of isoelectric focusing.

29. The method as claimed in one of the preceding claims, characterized in that peptide-containing and protein-containing samples containing lipophilic and hydrophilic constituents are separated electrophoretically.

30. The method as claimed in one of the preceding claims, characterized in that lipophilic constituents of peptide-containing and protein-containing samples are separated electrophoretically.
